(19) United States
(12) Patent Application Publication
(10) Pub. No.: US 2026/0154725 A1
(43) Pub. Date: Jun. 4, 2026

(54) RECOMMENDATION METHOD AND APPARATUS BASED ON DECOUPLING LEARNING AND TARGET BEHAVIOR GUIDED LEARNING

(71) Applicant: National University of Defense Technology, Changsha (CN)

(72) Inventors: Yijia ZHANG, Changsha (CN); Wanyu CHEN, Changsha (CN); Feng QI, Changsha (CN); Fei CAI, Changsha (CN); Chaofan LIU, Changsha (CN)

(73) Assignee: National University of Defense Technology, Changsha (CN)

(21) Appl. No.: 19/258,788

(22) Filed: Jul. 2, 2025

(30) Foreign Application Priority Data
Dec. 3, 2024 (CN) 202411761795.8

(51) Int. Cl. G06Q 30/0601

(52) U.S. Cl. CPC G06Q 30/06311

(57) ABSTRACT

A recommendation method includes the following steps: constructing a user project interaction graph under behaviors based on an interaction between a user and a project under a plurality of behaviors; performing decoupling attribute domain characterization processing on the user project interaction graph to obtain project decomposition embedding corresponding to a project node and user decomposition embedding corresponding to a user node in a plurality of decoupled attribute domains; for the plurality of attribute domains corresponding to the user project interaction graph, calculating an attention score between the user node under the attribute domains and a project node adjacent to the user node based on the project decomposition embedding and the user decomposition embedding.

### CROSS-REFERENCE TO RELATED APPLICATIONS

The application claims priority to Chinese Patent Application No. 202411761795.8, filed on Dec. 3, 2024, the content of which is incorporated herein by reference in its entirety.

### TECHNICAL FIELD

The present disclosure belongs to a recommendation method, and in particular, relates to a recommendation method and apparatus based on decoupling learning and target behavior guided learning.

### BACKGROUND

In a recommendation system, it is very important to use various user behaviors, such as clicking, favoriting and purchasing, to alleviate an inherent sparsity problem in single behavior data. Multi-behavior recommendation refers to a recommendation method in consideration of a plurality of behaviors of a user (such as clicking, purchasing, commenting, etc.) in the recommendation system. This method can understand interests and preferences of the user more comprehensively, thus improving the accuracy of recommendation and user satisfaction.

The existing multi-behavior recommendation methods mainly use a graph network method to model the semantic interaction between a user and a project under different behaviors. These methods based on a graph network obtain the final user (project) embedding characterization by modeling the interaction between a user and a project in different behaviors and aggregating the embedding learned from different user project behaviors. There are also some methods that use contrastive learning to further improve the model performance by adjusting the user preference between the target behavior and the auxiliary behavior. Although the performance of multi-behavior recommendation is significantly improved by combining contrastive learning with a graph neural network, multi-behavior recommendation still faces two main problems.

Firstly, these methods do not take into account the fine-grained relationship of preferences for the specific item attributes between the target behavior and the auxiliary behavior of the user. The project attribute reflects the preferences of the user, and there is a correlation between a plurality of behaviors for the specific project attributes.

Secondly, when learning the user preference of the target behavior, the existing methods ignore the noise data in the auxiliary behavior. The noise data in the auxiliary behavior is mainly reflected in some item attributes that are not related to the target user behavior. Even some items that seem to be irrelevant to the target behavior still provide useful information for predicting the target behavior of specific item attributes.

In the actual application scenario, the auxiliary behavior, such as clicking and adding to a shopping cart, which is inconsistent with the target purchasing behavior has a negative impact on the recommendation accuracy of the target user behavior preferences, while the commonly used methods in the prior art usually only learn the coarse-grained user preferences and fail to take into account the subtle attributes of the projects that the user pays attention to in different behaviors, resulting in poor accuracy of the recommendation result.

### SUMMARY

The technical problem to be solved by the present disclosure is that the commonly used methods in the prior art usually only learn the coarse-grained user preferences and fail to take into account the subtle attributes of the projects that the user pays attention to in different behaviors, resulting in poor accuracy of the recommendation result. In order to solve the above-mentioned problems, the present disclosure provides a recommendation method and apparatus based on decoupling learning and target behavior guided learning.

The present disclosure includes the following content.

In a first aspect, an embodiment of the present disclosure provides a recommendation method based on decoupling learning and target behavior guided learning, including:
constructing a user project interaction graph under each of a plurality of behaviors based on an interaction between a user and a project under the plurality of behaviors, where the user project interaction graph includes a user node for characterizing the user and a project node for characterizing the project, and the plurality of behaviors include a target behavior and an auxiliary behavior;
performing decoupling attribute domain characterization processing on the user project interaction graph to obtain project decomposition embedding corresponding to the project node and user decomposition embedding corresponding to the user node in a plurality of decoupled attribute domains;
for the plurality of attribute domains corresponding to each of the user project interaction graphs, calculating an attention score between the user node under each of the attribute domains and a project node adjacent to the user node based on the project decomposition embedding and the user decomposition embedding;
performing aggregating processing on the user node and the project node based on the attention score to obtain user target embedding and project target embedding under each of the behaviors; and
performing analysis processing in combination with the user target embedding and the project target embedding under the plurality of behaviors to obtain a recommended result.

Optionally, performing decoupling attribute domain characterization processing on the user project interaction graph to obtain project decomposition embedding corresponding to the project node and user decomposition embedding corresponding to the user node in a plurality of decoupled attribute domains includes:
constructing the plurality of decoupled attribute domains, and acquiring user initial embedding corresponding to the user node and initial project embedding corresponding to the project node; and
decomposing the initial project embedding in each of the attribute domains to obtain the project decomposition embedding in the attribute domain, and determining the user decomposition embedding in each of the attribute domains based on the user initial embedding.

Optionally, decomposing the initial project embedding in each of the attribute domains to obtain the project decomposition embedding in the attribute domain includes:
in each of the attribute domains, projecting the initial project embedding into embedding of the attribute domain by using a pre-learned projection matrix to obtain the project decomposition embedding in the attribute domain, where the project decomposition embedding in the attribute domain is as follows:

$${e}_{i , a} = \frac{{W}_{b} {e}_{i}}{{‖ {W}_{b} {e}_{i} ‖}_{2}}$$

where e_{i,a}∈ [symbol] is used to characterize the project decomposition embedding of a project node i in the attribute domain a, eᵢ is used to characterize the initial project embedding of the project node i, W_{b}∈ [symbol] is used to characterize the projection matrix, the projection matrix is a learnable parameter matrix, and ∥ ∥₂ is used to characterize L2 norm.

Optionally, calculating an attention score between the user node under each of the attribute domains and a project node adjacent to the user node based on the project decomposition embedding and the user decomposition embedding includes:
determining a mean value of the project decomposition embedding of all adjacent project nodes corresponding to the user node in the attribute domain as a query vector corresponding to the user node; and
using the query vector corresponding to the user node to calculate the attention score between the user node and the project node adjacent to the user node in the attribute domain.

Optionally, the attention score between the user node and the project node adjacent to the user node is as follows:

$${α}_{u , i}^{a} = Softmax \{ {W}_{a} [ {q}_{u , a} ; {e}_{i , a}^{0} ] \}$$

where q_{u,a}∈ [symbol] is used to characterize the query vector corresponding to the user node u in the attribute domain a under the target behavior, Wₐ∈ [symbol] is a pre-learned parameter, [;] is used to characterize the cascade of vectors, and

$${e}_{i , a}^{0}$$

is used to characterize the project decomposition embedding of the project node i in the attribute domain a.

Optionally, performing aggregating processing on the user node and the project node based on the attention score to obtain user target embedding and project target embedding under each of the behaviors includes:
aggregating the user node and the project node adjacent to the user node based on the attention score to obtain user aggregation embedding, and aggregating the project node and a user node adjacent to the project node to obtain project aggregation embedding;
adding the user aggregation embedding in all of the attribute domains under the same user project interaction graph to obtain user target embedding under the behavior, and adding the project aggregation embedding in all of the attribute domains under the same user project interaction graph to obtain project target embedding under the behavior.

Optionally, the project is a commodity, the target behavior is purchasing, and the auxiliary behavior includes at least one of clicking, favoriting and commenting;
the interaction between the user and the project under the plurality of behaviors is used to characterize the situation that the user performs the target behavior and the auxiliary behavior on the commodity, and the attribute domain is used to characterize the attribute of the commodity.

In a second aspect, an embodiment of the present disclosure provides a recommendation apparatus based on decoupling learning and target behavior guided learning, including:
a construction module, which is configured to construct a user project interaction graph under each of a plurality of behaviors based on an interaction between a user and a project under the plurality of behaviors, where the user project interaction graph includes a user node for characterizing the user and a project node for characterizing the project, and the plurality of behaviors include a target behavior and an auxiliary behavior;
a decoupling characterization module, which is configured to perform decoupling attribute domain characterization processing on the user project interaction graph to obtain project decomposition embedding corresponding to the project node and user decomposition embedding corresponding to the user node in a plurality of decoupled attribute domains;
an attention calculation module, which is configured to, for the plurality of attribute domains corresponding to each of the user project interaction graphs, calculate an attention score between the user node under each of the attribute domains and a project node adjacent to the user node based on the project decomposition embedding and the user decomposition embedding;
an aggregation processing module, which is configured to perform aggregating processing on the user node and the project node based on the attention score to obtain user target embedding and project target embedding under each of the behaviors; and
an analysis processing module, which is configured to perform analysis processing in combination with the user target embedding and the project target embedding under the plurality of behaviors to obtain a recommended result.

In a third aspect, an embodiment of the present disclosure provides an electronic device, including: a memory, a processor, and a program stored in the memory and executable on the processor; where the processor is configured to read the program in the memory to implement the steps in the recommendation method based on decoupling learning and target behavior guided learning as described in the first aspect.

In a fourth aspect, an embodiment of the present disclosure provides a readable storage medium in which a program is stored, where the program, when executed by a processor, implements the steps in the recommendation method based on decoupling learning and target behavior guided learning as described in the first aspect.

The present disclosure has the following beneficial effects. In this embodiment, the user project interaction under different behaviors is characterized in a plurality of decoupled attribute domains, and the user preference is reflected through a fine-grained project attribute. Based on the decoupled graph convolution network, the user preference for different project attributes is learned to capture the fine-grained semantic interaction between a user and a project in different attribute spaces. Through the method provided by this embodiment, the subtle attributes of the project that the user pays attention to in different behaviors are taken into account, which can improve the understanding of the user preferences and improve the recommendation quality in a complex behavior environment, thus obtaining a more accurate recommendation result.

### BRIEF DESCRIPTION OF THE DRAWINGS

FIG. 1 is a flowchart of a recommendation method based on decoupling learning and target behavior guided learning according to an embodiment of the present disclosure.

FIG. 2 is an architecture diagram of a recommendation method based on decoupling learning and target behavior guided learning according to an embodiment of the present disclosure.

FIG. 3 is a schematic diagram of a process of acquiring a user project interaction graph according to an embodiment of the present disclosure.

FIG. 4a is a schematic diagram of a convolution part of a decoupling graph according to an embodiment of the present disclosure.

FIG. 4b is a partially enlarged schematic diagram of a corresponding part of an attribute domain 1 in FIG. 4a.

FIG. 4c is a partially enlarged schematic diagram of a corresponding part of an attribute domain K in FIG. 4a.

FIG. 5 is a schematic diagram of a decoupling contrastive learning part according to an embodiment of the present disclosure.

FIG. 6 is a schematic diagram of a recommendation apparatus based on decoupling learning and target behavior guided learning according to an embodiment of the present disclosure.

FIG. 7 is a schematic structural diagram of an electronic device according to an embodiment of the present disclosure.

### DETAILED DESCRIPTION OF THE EMBODIMENTS

The term “and/or” in the embodiment of the present disclosure describes the relationship of related objects, indicating that there can be three relationships, for example, A and/or B, which can indicate that A exists alone, A and B exist at the same time, and B exists alone. The character “/” generally indicates that the context associated objects form an “OR” relationship. In the embodiment of the present disclosure, the term “a plurality of” refers to two or more, and other quantifiers are similar. The terms “first” and “second” in the specification and claims of the present disclosure are used to distinguish similar objects, and are not used to describe a specific order or sequence. It should be understood that the terms used in this way can be interchanged when appropriate, so that the embodiments of the present disclosure can be implemented in an order other than those illustrated or described here. Further, the objects distinguished by “first” and “second” usually belong to one type, and the number of objects is not limited. For example, there may be one or more first objects.

In the following, the technical solution in the embodiments of the present disclosure will be clearly and completely described with reference to the attached drawings. Obviously, the described embodiments are only some of the embodiments of the present disclosure, rather than all of the embodiments. Based on the embodiments in the present disclosure, all other embodiments obtained by those skilled in the art without paying creative labor belong to the protection scope of the present disclosure.

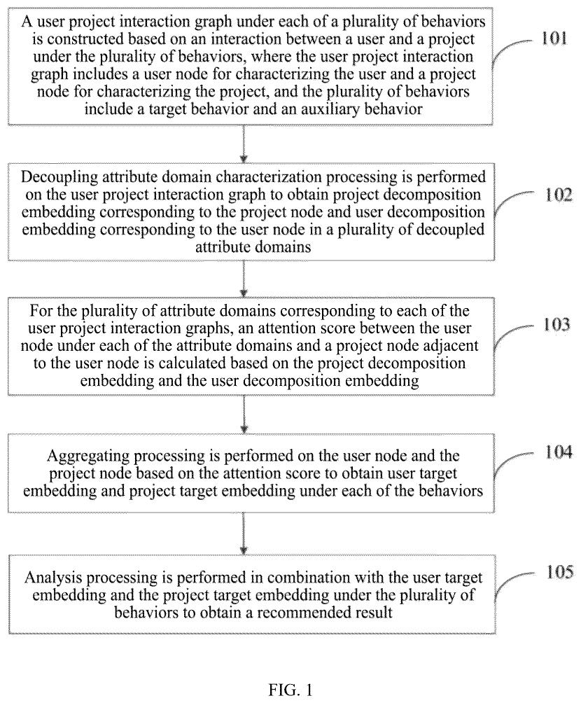

Referring to FIG. 1, which is a schematic diagram of a recommendation method based on decoupling learning and target behavior guided learning according to an embodiment of the present disclosure, the method specifically includes the following steps.

Step 101, a user project interaction graph under each of a plurality of behaviors is constructed based on an interaction between a user and a project under the plurality of behaviors, where the user project interaction graph includes a user node for characterizing the user and a project node for characterizing the project, and the plurality of behaviors include a target behavior and an auxiliary behavior.

Step 102, decoupling attribute domain characterization processing is performed on the user project interaction graph to obtain project decomposition embedding corresponding to the project node and user decomposition embedding corresponding to the user node in a plurality of decoupled attribute domains.

Step 103, for the plurality of attribute domains corresponding to each of the user project interaction graphs, an attention score between the user node under each of the attribute domains and a project node adjacent to the user node is calculated based on the project decomposition embedding and the user decomposition embedding.

Step 104, aggregating processing is performed on the user node and the project node based on the attention score to obtain user target embedding and project target embedding under each of the behaviors.

Step 105, analysis processing is performed in combination with the user target embedding and the project target embedding under the plurality of behaviors to obtain a recommended result.

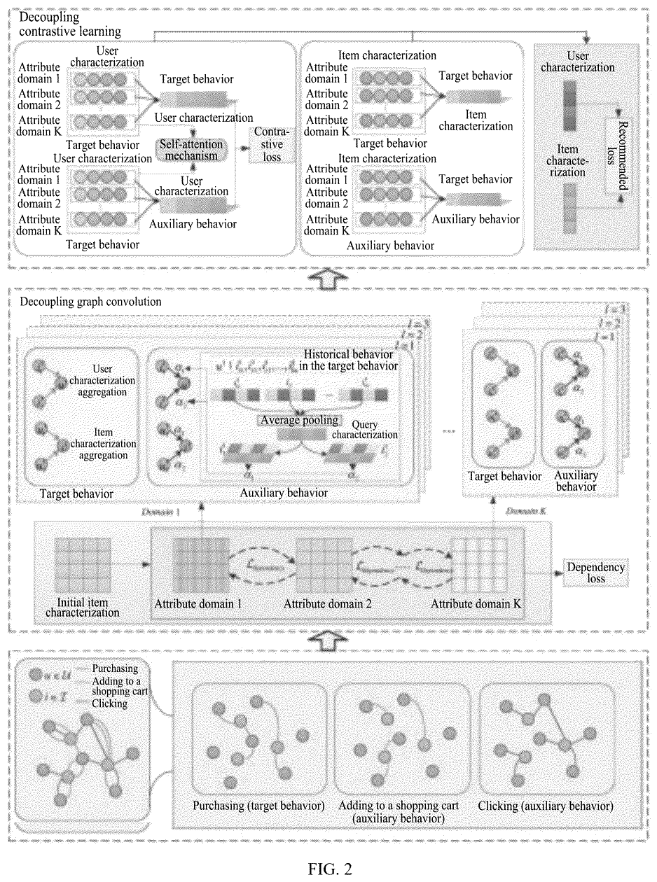

Referring to FIG. 2, the embodiment of the present disclosure further provides an architecture of recommendation method based on decoupling learning and target behavior guided learning. The architecture specifically includes four modules, namely, a decoupling attribute domain characterization model for implementing Step 102, a target behavior guided attention mechanism module for implementing Step 103, a decoupling graph attention network module for implementing Step 103, and a denoising contrastive learning module for training.

Different steps or modules will be introduced in detail below. In specific implementation, user embedding can also be referred to as user features or user characterization, and project embedding can also be referred to as project features or project characterization. As a specific embodiment, the project can be the item targeted by the user behavior. For example, when the behavior is purchasing, the project is the purchased item.

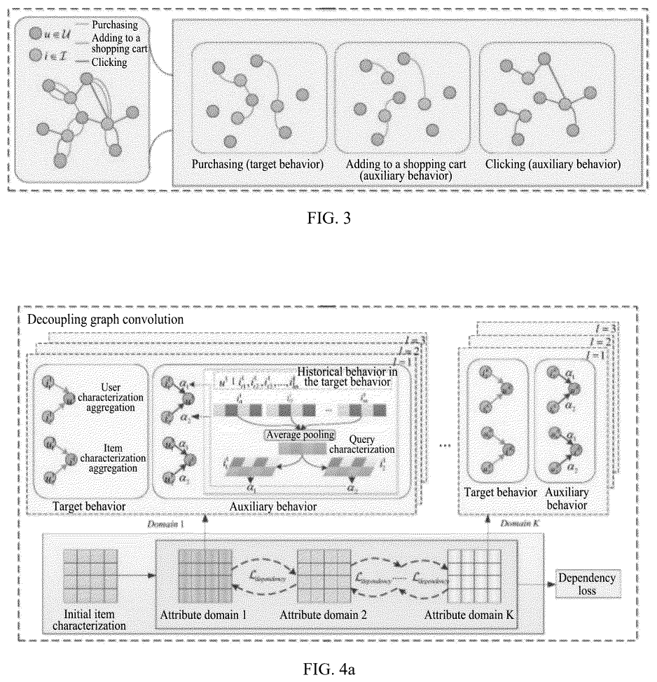

Referring to FIG. 3, in Step 101, first, an interaction between a user and a project under the plurality of behaviors is acquired. In specific embodiments, the number of users and projects can be multiple. The plurality of behaviors include target behaviors and auxiliary behaviors. In some embodiments, the number of auxiliary behaviors is one or more. For example, in the specific embodiment shown in FIG. 3, behaviors include purchasing, adding to a shopping cart and clicking, where purchasing is the target behavior, and adding to a shopping cart and clicking are the auxiliary behaviors.

In Step 101, a user project interaction graph under different behaviors is established, respectively. In the user project interaction graph under this behavior, if a user interacts with a project under this behavior (for example, user A adds project A to a shopping cart, that is, user A interacts with project A under the purchasing behavior), the user node characterizing the user is connected with the project node characterizing the project. In the specific embodiment shown in FIG. 3, the corresponding user project interaction graphs are obtained for the three behaviors of purchasing, adding to a shopping cart and clicking.

In Step 102, the project node and the user node in the user project interaction graph are projected into a plurality of decoupled attribute domains to characterize the attractiveness of different project attributes to the user under different behaviors. The correlation between user preferences in different behaviors is mainly reflected in different project attributes, and the noise data in auxiliary behaviors are also closely related to project attributes. Through this step, the preferences of the user for project attributes under different behaviors can be paid attention to. Therefore, more accurate embedding can be obtained by paying attention to specific project attributes.

Optionally, in some embodiments, Step 102 includes:
constructing the plurality of decoupled attribute domains, and acquiring user initial embedding corresponding to the user node and initial project embedding corresponding to the project node; and
decomposing the initial project embedding in each of the attribute domains to obtain the project decomposition embedding in the attribute domain, and determining the user decomposition embedding in each of the attribute domains based on the user initial embedding.

In this embodiment, several decoupled attribute domains are constructed to characterize different project attribute domains. Attribute domains are implicit spaces. Different from explicit project categories and user attributes, the attribute domains are potential semantic spaces to characterize implicit potential item attributes. For example, when the project is a clothing item, the attribute domains can characterize the version, color, price, material and other attributes of the clothing. In the specific implementation, the number of attribute domains is not limited here, and each user project interaction graph corresponds to a plurality of attribute domains.

It should be understood that, unless otherwise specified, the attribute domains referred to in various embodiments include each attribute domain corresponding to each user project interaction graph (i.e., under all behaviors), and the steps performed in all of the attribute domains are the same, which will not be described in detail.

In some embodiments, each of the users and projects is associated with ID embedding. It is assumed that P∈ [symbol] is the embedding matrix of user embedding initialization, and Q∈R^{N×D} is the embedding matrix of project embedding initialization, where M represents the number of users, N represents the number of projects, and D represents the embedding size. Formally, a unique hot coding embedding matrix [symbol] for the user and a unique hot coding embedding matrix [symbol] of the project are given, which are specifically as follows:

$${e}_{u} = P \cdot {ID}_{u}^{𝒰}$$

$${e}_{i} = Q \cdot {ID}_{i}^{𝒥}$$

where eᵤ is the initial user embedding of user u,

$${ID}_{u}^{𝒰}$$

is a unique hot coding vector corresponding to user u, eᵢ is the initial project embedding of project i, and

$${ID}_{i}^{𝒥}$$

is a unique hot coding vector of project i.

In each attribute domain, the project decomposition embedding is obtained by decomposing the initial project embedding. Assuming that A is A=1, 2, . . . , |A|, A is a hyper-parameter representing the number of decoupled attribute domains, the eᵢ obtained above is projected into the embedding of the attribute a∈A by using the projection matrix. Specifically, in some embodiments, decomposing the initial project embedding in each of the attribute domains to obtain the project decomposition embedding in the attribute domain includes:
in each of the attribute domains, projecting the initial project embedding into embedding of the attribute domain by using a pre-learned projection matrix to obtain the project decomposition embedding in the attribute domain, where the project decomposition embedding in the attribute domain is as follows:

$${e}_{i , a} = \frac{{W}_{b} {e}_{i}}{{‖ {W}_{b} {e}_{i} ‖}_{2}}$$

where e_{i,a}∈ [symbol] is used to characterize the project decomposition embedding of a project node i in the attribute domain a, eᵢ is used to characterize the initial project embedding of the project node i, W_{b}∈ [symbol] is used to characterize the projection matrix, the projection matrix is a learnable parameter matrix, and ∥∥2 is used to characterize L2 norm. In some embodiments, W_{b}∈ [symbol] is the projection matrix of the attribute domain shared by all of the projects.

It should be understood that in this embodiment, initial embedding input into the graph attention network is the same as the project decomposition embedding, that is:

$${e}_{i , a}^{0} = {e}_{i , a}$$

Optionally, in some embodiments, the specific method of determining the user decomposition embedding in each of the attribute domains based on the user initial embedding is as follows:
using the transformation matrix

$${M}_{u}^{a}$$

∈ [symbol] to obtain the user decomposition embedding, which is used as the initial embedding input into the graph attention network, as shown below:

$${e}_{u a}^{0} = {e}_{u} \cdot {M}_{u}^{a}$$

Because different attribute domains should contain different information about project attributes, otherwise a plurality of project embedding will degenerate into one project embedding. Therefore, it is necessary to separate the project embedding in different attribute domains. In order to improve the model capacity and the interpretability, and avoid redundant information, independency loss is introduced in this embodiment for constraints to ensure the independency of different attribute domains and prevent them from degenerating into a single attribute domain.

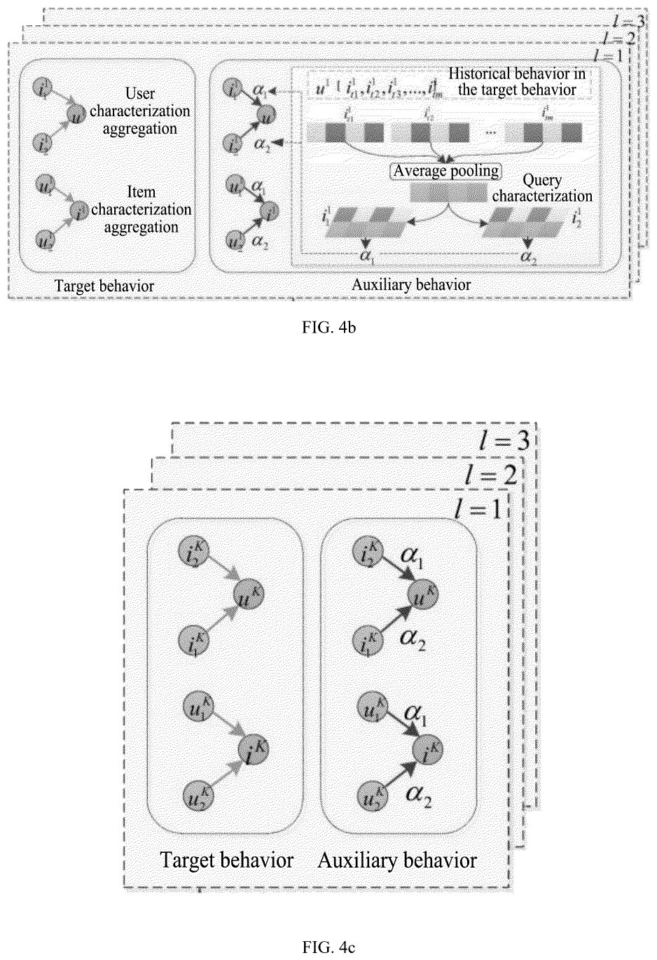

Referring to FIG. 4a to FIG. 4c, specifically, in this embodiment, mutual information can be used to encourage the separation of project decomposition embedding in different attribute domains. For each project i, the mutual score is as follows:

$${ℒ}_{i n d}^{i} = {\sum }_{b ∈ A} - log \frac{exp ( \frac{s ( {e}_{i , a} , {e}_{i , a} )}{τ} )}{{\sum }_{{a}^{′} ∈ A} exp ( \frac{s ( {e}_{i , a} , {e}_{i , {a}^{′}} )}{τ} )}$$

where s(⋅) is a function to measure the similarity of project decomposition embedding corresponding to two identical projects in different attribute domains, τ represents the temperature in the softmax function as a hyper-parameter, and A is a set of attribute domains.

In some embodiments, s(⋅) is set as a cosine similarity function, which is shown as follows:

$$s ( {e}_{1} , {e}_{2} ) = \frac{{e}_{1} {e}_{2}^{T}}{{‖ {e}_{1} ‖}_{2} {‖ {e}_{2} ‖}_{2}}$$

The final dependent loss consists of the mutual scores of all projects, and the specific calculation method is shown as follows:

$${ℒ}_{i n d} = {\sum }_{i ∈ 𝒥} {ℒ}_{i n d}^{i}$$

As shown in FIG. 2, in Step 103, an attention mechanism based on target behavior guided learning is designed for each attribute domain, so that the message delivery of the graph neural network is modified according to the user preference for the target behavior. For all the adjacent project nodes of the user in a specific attribute domain, if the project embedding in the attribute domain is closer to the target behavior preference of the user, the information transmitted by the project node to the user node in the attribute domain should have higher importance weight than other adjacent project nodes.

Optionally, in some embodiments, Step 103 includes:
determining a mean value of the project decomposition embedding of all adjacent project nodes corresponding to the user node in the attribute domain as a query vector corresponding to the user node; and
using the query vector corresponding to the user node to calculate the attention score between the user node and the project node adjacent to the user node in the attribute domain.

In this embodiment, in order to learn the attention score of the user node u and the project node i adjacent to the user node in the attribute domain a, a query vector q that can reflect the target behavior preference of the user node u is learned first. Specifically, in some embodiments, a query vector is calculated in each attribute domain in each user behavior, and different behaviors need to calculate different query vectors. The query vector is the mean value of all project characterizations that the user has interacted with, and can thus represent the user preference. The mean value of the project decomposition embedding of all the project nodes interacting with the user node u in the attribute domain a is determined as the query vector, which is shown as follows:

$${q}_{u , a} = mean \{ {e}_{i , 1}^{u , a} , {e}_{i , 2}^{u , a} , … , {e}_{i , n}^{u , a} \}$$

where q_{u,a}∈ [symbol] is used to characterize the query vector corresponding to the user node u in the attribute domain a under the target behavior, and

$${e}_{i , n}^{u , a}$$

∈ [symbol] represents an n-th project node adjacent to the user node u in the attribute domain a. In the formula

$${q}_{u , a} = mean \{ {e}_{i , 1}^{u , a} , {e}_{i , 2}^{u , a} , … , {e}_{i , n}^{u , a} \} ,$$

Then, the learned query vector can be used to calculate the attention scores of the user node and the project node adjacent to the user node. Optionally, in some embodiments, the attention score between the user node and the project node adjacent to the user node is as follows:

$${α}_{u , i}^{a} = Softmax \{ {W}_{a} [ {q}_{u , a} ; {e}_{i , a}^{0} ] \}$$

where q_{u,a}∈ [symbol] is used to characterize the query vector corresponding to the user node u in the attribute domain a under the target behavior, Wₐ∈ [symbol] is a pre-learned parameter, [;] is used to characterize the cascade of vectors, and

$${e}_{i , a}^{0}$$

is used to characterize the project decomposition embedding of the project node i in the attribute domain a.

It should be understood that the attention score of each user node and the project node adjacent to the user node can be calculated in each attribute domain. After obtaining the attention score of each user node and the project node adjacent to the user node, it is equivalent to obtaining the attention score of each project node and the user node adjacent to the project node.

Optionally, in some embodiments, Step 104 includes:
aggregating the user node and the project node adjacent to the user node based on the attention score to obtain user aggregation embedding, and aggregating the project node and the user node adjacent to the project node to obtain project aggregation embedding;
adding the user aggregation embedding in all of the attribute domains under the same user project interaction graph to obtain user target embedding under the behavior, and adding the project aggregation embedding in all of the attribute domains under the same user project interaction graph to obtain project target embedding under the behavior.

As shown in FIG. 2, after obtaining the attention score between the user node and the project node adjacent to the user node, the graph attention network is used for aggregation processing. For each attribute domain, the Graph Attention Network (GAT) is designed by incorporating the attention guided by the target behavior into the graph neural network, and then the GAT is used to aggregate the neighbors of the user (project) nodes and distinguish the attraction intensity of different project attributes to users.

In some embodiments, based on the LightGCN method, an aggregation function under a specific auxiliary behavior is designed, which is shown as follows:

$${e}_{u , a}^{l + 1} = {\sum }_{i ∈ {𝒩}_{( u )}} {α}_{u , i}^{a , l} {e}_{i , a}^{l}$$

$${e}_{i , a}^{l + 1} = {\sum }_{u ∈ {𝒩}_{( i )}} {α}_{u , i}^{a , l} {e}_{u , a}^{l}$$

where [symbol] is used to represent the adjacent node of the user node u, [symbol] is used to represent the adjacent node of the project node i, l is used to represent the number of layers of the graph attention network,

$${e}_{u , a}^{l + 1}$$

∈ [symbol] is used to represent the user decomposition embedding of the user node u of the (l+1)ₜₕ layer in the attribute domain a,

$${e}^{l + 1}$$

∈ [symbol] is used to represent the project decomposition embedding of the project node i of the (l+1)ₜₕ layer in the attribute domain a, and

$${α}_{u , i}^{a , l}$$

is used to represent the attention scores of the user u in the l-th layer and the adjacent project node i in attribute domain a.

The value of

$${α}_{u , i}^{a , l}$$

corresponding to each attribute domain under the target behavior is set to 1. Through the graph attention network of the L layers, the attribute domain {1, 2, . . . , A} under the auxiliary behavior k can obtain:

$${e}_{u}^{k} = {\sum }_{a ∈ A} {e}_{u , a}^{k}$$

$${e}_{i}^{k} = {\sum }_{a ∈ A} {e}_{i , a}^{k}$$

where

$${e}_{u , a}^{k}$$

is used to represent the embedding of the user node u in the attribute domain a under the auxiliary behavior k obtained through the L-layer graph attention network, and

$${e}_{i , a}^{k}$$

is used to represent the embedding of the project node i in the attribute domain a under the auxiliary behavior k obtained through the L-layer graph attention network.

In the above manner, the embedding corresponding to the same user node in all of the attribute domains under the same behavior are summed to obtain the user target embedding of the user node under this behavior. Similarly, the embedding of the same project node in all domains under the same behavior is summed to obtain the project target embedding of the project node under this behavior.

In the embodiment of the present disclosure, a graph attention mechanism guided by the target behavior is designed in the graph convolution network to obtain the graph attention network. The target user behavior preference can guide the user project interactive learning in the auxiliary behavior. The project attributes in which the user is interested in the auxiliary behavior can be effectively extracted by incorporating the attention mechanism into the graph convolution network, while reducing the influence of irrelevant project attributes.

Optionally, in some embodiments, performing analysis processing in combination with the user target embedding and the project target embedding under the plurality of behaviors to obtain a recommended result includes:
determining user final embedding based on the user target embedding under all of the behaviors, and determining a final project embedding based on the project target embedding under all of the behaviors;
performing analysis processing based on the final user embedding and the final project embedding to obtain the recommendation result.

After obtaining the user target embedding and the target project embedding in each of K behaviors {1, 2, . . . , K}, the user final embedding and the project final embedding in all of the behaviors can be further determined. In some embodiments, the final user embedding and the final project embedding are as follows:

$${e}_{u} = {W}_{u} ( [ {e}_{u}^{1} ; {e}_{u}^{2} ; … ; {e}_{u}^{K} ] + {b}_{u} )$$

$${e}_{i} = {W}_{i} ( [ {e}_{i}^{1} ; {e}_{i}^{2} ; … ; {e}_{i}^{K} ] + {b}_{i} )$$

where Wᵤ∈ [symbol] and Wᵢ∈ [symbol] represent weight matrices, bᵤ∈ [symbol] and bᵢ∈ [symbol] represent offset parameters. In the specific implementation, the final recommendation result can be obtained by performing analysis processing based on the user final embedding and the final project embedding, and the specific process can be described in related technologies, which is not described in detail here.

This embodiment further provides a recommendation model, which includes the decoupling domain characterization module, the target behavior guided attention mechanism module and the decoupling graph attention network module. In the process of training the recommendation model, in order to learn the correlation between the embedding representing the user target behavior and the auxiliary behavior, a contrastive learning method is used to allow the embedding of the user target behavior and the auxiliary behavior to be more consistent. Because the embedding of the auxiliary behavior contains a lot of noise data, such as click behaviors resulted from the popularity of the project, these noise data will lead to the noise information in the embedding of the auxiliary behavior to be used as positive samples, which will reduce the ability to distinguish positive samples from negative samples in contrastive learning.

In this embodiment, a denoising contrastive learning method is provided to reduce the noise information in the positive samples, so as to maximize the effectiveness of contrastive learning in the recommendation model. Through the embedding learning module based on the graph attention network, the user embedding of the auxiliary behavior can be obtained by effectively capturing the user project interaction of the target behavior preference, which can reduce more noise data in the auxiliary behavior compared with the method based on the graph convolution network commonly used in the prior art.

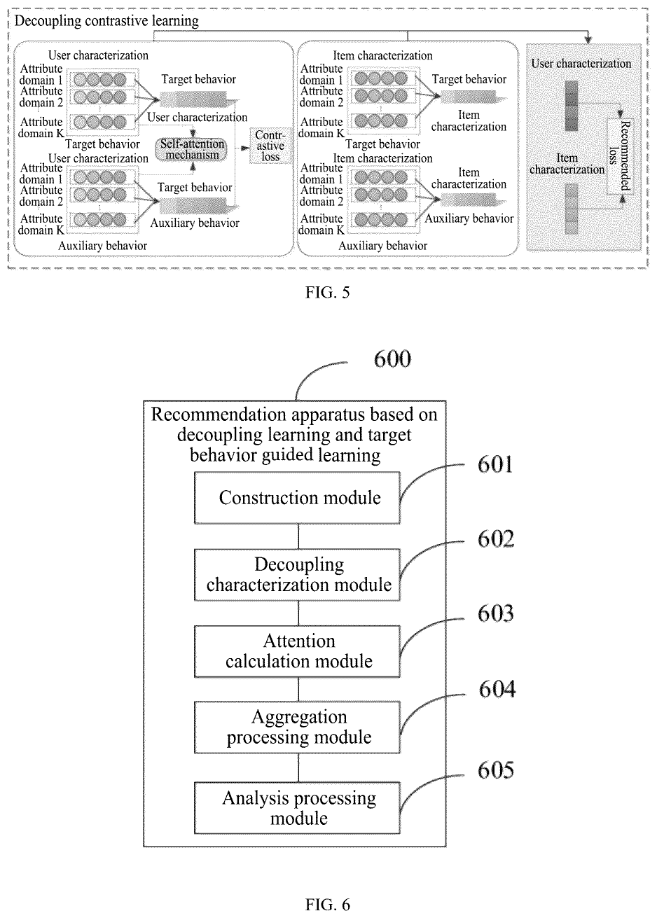

As shown in FIG. 5, a multi-attribute linearized attention mechanism is designed before the contrastive learning, in which the user target embedding of the target behavior is regarded as Q, and the user target embedding of the auxiliary behavior is regarded as K and V. First, the user target embedding is projected as follows:

$$Q = {W}_{Q} \cdot {E}_{u}^{K}$$

$$K = {W}_{K} \cdot {E}_{u}^{k}$$

$$V = {W}_{V} \cdot {E}_{u}^{k}$$

where

$${E}_{u}^{K}$$

represents a user embedding matrix of the target behavior,

$${E}_{u}^{k}$$

represents a user embedding matrix of the k-th auxiliary behavior of attribute a, and W_{Q}, W_{K}, W_{V}∈ [symbol] represents a parameter matrix. The number of behaviors is K, the first K−1 behaviors represent the auxiliary behaviors, and the K-th behavior represents the target behavior.

Then, the user target embedding of the k-th auxiliary behavior of attribute a uses a linearized attention mechanism, and the following function is used to calculate the attention weight:

$${\hat{E}}_{u}^{k} = ( ϕ ( Q ) ϕ ( {K}^{T} ) ) V$$

where the feature graph φ(⋅) is applied to the matrices Q and K in rows. Specifically, φ(x)=elu(x)+1, elu(⋅) represents an exponential linear unit activation function, and

$${\hat{E}}_{u}^{k}$$

∈ [symbol] is formed by

$$[ {\hat{E}}_{u , 1}^{k} , {\hat{E}}_{u , 2}^{k} , … , {\hat{E}}_{u , A}^{k} ] .$$

The linearized attention mechanism used in this embodiment can effectively reduce the complexity of the model.

In the above formula, when x is negative, the user targe embedding matrix

$${\hat{e}}_{u}^{k}$$

∈ [symbol] of the auxiliary behavior k can be calculated by adding a slice of the matrix of attribute dimensions as follows:

$${\hat{e}}_{u}^{k} = {\sum }_{a ∈ A} {\hat{E}}_{u , a}^{k}$$

Then, the user target embedding matrix

$${\hat{e}}_{u}^{1} , {\hat{e}}_{u}^{2} , … , {\hat{e}}_{u}^{K - 1}$$

of the auxiliary behavior can be obtained, and the user target embedding matrix of the target behavior is

$${\hat{e}}_{u}^{K} .$$

Contrastive learning is used to capture the fine-grained consistency between the target behavior and the auxiliary behavior of the user, and achieve a deeper and more accurate understanding of the user target behavior preference to obtain:

$${ℒ}_{c {l}_{k}}^{user} = {\sum }_{u ∈ U} - log \frac{exp ( \frac{ϕ ( {\hat{e}}_{u}^{k} , {\hat{e}}_{u}^{K} )}{τ} )}{{\sum }_{v ∈ U ∖ u} exp ( \frac{ϕ ( {\hat{e}}_{v}^{k} , {\hat{e}}_{u}^{K} )}{τ} )}$$

In the above formula, τ is the temperature hyper-parameter in softmax, and φ(⋅) represents an inner product of two vectors. The final contrastive loss function is as follows:

$${ℒ}_{cl} = {\sum }_{k = 1}^{K - 1} {ℒ}_{c {l}_{k}}^{user}$$

In this embodiment, a denoising contrastive learning method is designed to adjust the user preference between the target behavior and the auxiliary behavior. By denoising learning is performed on the user preferences for different project attributes in the auxiliary behavior, a higher weigh is assigned to the user features in the attribute domain that is more similar to the target behavior, so as to improve the purity of the positive samples and achieve more effective contrastive learning.

In order to optimize the current module, in some embodiments, pairwise Bayesian Personalized Ranking (BPR) loss is used for calculation, so that the associated nodes have similarities. The BPR loss function is as follows:

$${ℒ}_{bpr} = {\sum }_{( u , i , j ) ∈ O} log \{ σ ( {e}_{u}^{T} {e}_{i} - {e}_{u}^{T} {e}_{j} ) \}$$

where O is used to characterize the training sample set, σ is used to characterize the sigmoid function, superscript T is used to characterize the transposition operation, eᵤ is used to characterize the embedding of user node u, eᵢ is used to characterize the embedding of project node i, and eⱼ is used to characterize the embedding of project node j.

In some embodiments, the loss function of training the recommendation model is as follows:

$$ℒ = {ℒ}_{b p r} + α {ℒ}_{c l} + {βℒ}_{i n d} + μ {‖ Θ ‖}_{2}^{2}$$

where α, β and μ are hyper-parameters that control the contrastive loss, the dependency loss, the recommended task training loss, and L2 regularization ratio, respectively.

In this embodiment, the above-mentioned contrast loss is set, so that contrastive learning can be better utilized to enhance the consistency between the target user behavior and the auxiliary user behavior. In this embodiment, the importance weight of user preference for different attribute domains with respect to the target user behavior under the specific auxiliary behavior is also learned. By emphasizing the embedding of the user behavior in important attribute domains, the noise data in the auxiliary behavior embedding can be effectively reduced, so as to achieve fine-grained contrastive learning and reduce the influence of noise data on positive samples.

Optionally, in some embodiments, the project is a commodity, the target behavior is purchasing, and the auxiliary behavior includes at least one of clicking, favoriting and commenting;
the interaction between the user and the project under the plurality of behaviors is used to characterize the situation that the user performs the target behavior and the auxiliary behavior on the commodity, and the attribute domain is used to characterize the attribute of the commodity.

The recommendation method based on decoupling learning and target behavior guided learning according to the embodiment of the present disclosure can be used in the scene of personalized commodity recommendation for users. Projects can be commodities targeted by user behaviors, and behaviors performed by users can be purchasing, clicking, favoriting and commenting. In this embodiment, purchasing is determined as the target behavior, and other behaviors except the purchasing are determined as the auxiliary behaviors. Through historical data, the data of various operations performed by the user on a plurality of commodities (that is, the interaction between a user and a project under a plurality of behaviors) can be obtained.

In the scene of personalized product recommendation, it is usually necessary to recommend personalized products to users according to their historical behaviors. However, the behaviors of clicking, commenting and favoriting a commodity by the user do not necessarily mean that the user has a purchasing preference for the commodity. The commonly used recommendation methods in the prior art only learn coarse-grained user preferences, but fail to take into account the subtle attributes of commodities that the user pays attention to in different behaviors. Therefore, when performing personalized commodity recommendation for users with purchasing as the target behavior, the auxiliary behaviors such as clicking, commenting and favoriting in the user historical data may have a negative impact on the recommendation result.

Through the method according to this embodiment, the user preference between the target behavior and the auxiliary behavior can be adjusted, the commodity attributes that the user is interested in the auxiliary behavior can be effectively extracted, and the influence of irrelevant commodity attributes can be reduced at the same time, so as to capture the fine-grained semantic interaction between the user and the commodity in different attribute spaces and improve the accuracy of the obtained recommendation result.

Referring to FIG. 6, an embodiment of the present disclosure further provides a recommendation apparatus based on decoupling learning and target behavior guided learning 600, including:
a construction module 601, which is configured to construct a user project interaction graph under each of a plurality of behaviors based on an interaction between a user and a project under the plurality of behaviors, where the user project interaction graph includes a user node for characterizing the user and a project node for characterizing the project, and the plurality of behaviors include a target behavior and an auxiliary behavior;
a decoupling characterization module 602, which is configured to perform decoupling attribute domain characterization processing on the user project interaction graph to obtain project decomposition embedding corresponding to the project node and user decomposition embedding corresponding to the user node in a plurality of decoupled attribute domains;
an attention calculation module 603, which is configured to, for the plurality of attribute domains corresponding to each of the user project interaction graphs, calculate an attention score between the user node under each of the attribute domains and the project node adjacent to the user node based on the project decomposition embedding and the user decomposition embedding;
an aggregation processing module 604, which is configured to perform aggregating processing on the user node and the project node based on the attention score to obtain user target embedding and project target embedding under each of the behaviors; and
an analysis processing module 605, which is configured to perform analysis processing in combination with the user target embedding and the project target embedding under the plurality of behaviors to obtain a recommended result.

Optionally, the decoupling characterization module 602 includes:
a first processing unit, which is configured to construct the plurality of decoupled attribute domains, and acquire user initial embedding corresponding to the user node and initial project embedding corresponding to the project node; and
a decomposition unit, which is configured to decompose the initial project embedding in each of the attribute domains to obtain the project decomposition embedding in the attribute domain, and determine the user decomposition embedding in each of the attribute domains based on the user initial embedding.

Optionally, the decomposition unit is specifically configured to:
in each of the attribute domains, project the initial project embedding into embedding of the attribute domain by using a pre-learned projection matrix to obtain the project decomposition embedding in the attribute domain, where the project decomposition embedding in the attribute domain is as follows:

$${e}_{i , a} = \frac{{W}_{b} {e}_{i}}{{‖ {W}_{b} {e}_{i} ‖}_{2}}$$

where e_{i,a}∈ [symbol] is used to characterize the project decomposition embedding of a project node i in the attribute domain a, eᵢ is used to characterize the initial project embedding of the project node i, W_{b}∈ [symbol] is used to characterize the projection matrix, the projection matrix is a learnable parameter matrix, and ∥ ∥₂ is used to characterize L2 norm.

Optionally, the attention calculation module 603 includes:
a first determining unit, which is configured to determine a mean value of the project decomposition embedding of all adjacent project nodes corresponding to the user node in the attribute domain as a query vector corresponding to the user node; and
a calculating unit, which is configured to use the query vector corresponding to the user node to calculate the attention score between the user node and the project node adjacent to the user node in the attribute domain.

Optionally, the attention score between the user node and the project node adjacent to the user node is as follows:

$${α}_{u , i}^{a} = Softmax \{ {W}_{a} [ {q}_{u , a} ; {e}_{i , a}^{0} ] \}$$

where q_{u,a}∈ [symbol] is used to characterize the query vector corresponding to the user node u in the attribute domain a under the target behavior, Wₐ∈ [symbol] is a pre-learned parameter, [;] is used to characterize the cascade of vectors, and

$${e}_{i , a}^{0}$$

is used to characterize the project decomposition embedding of the project node i in the attribute domain a.

Optionally, the aggregation processing module 604 includes:
an aggregation unit, which is configured to aggregate the user node and the project node adjacent to the user node based on the attention score to obtain user aggregation embedding, and aggregate the project node and the user node adjacent to the project node to obtain project aggregation embedding;
an adding unit, which is configured to add the user aggregation embedding in all of the attribute domains under the same user project interaction graph to obtain user target embedding under the behavior, and add the project aggregation embedding in all of the attribute domains under the same user project interaction graph to obtain project target embedding under the behavior.

Optionally, the analysis processing module 605 includes:
a second determining unit, which is configured to determine user final embedding based on the user target embedding under all of the behaviors, and determine a final project embedding based on the project target embedding under all of the behaviors;
an analysis processing unit, which is configured to perform analysis processing based on the final user embedding and the final project embedding to obtain the recommendation result.

Optionally, in some embodiments, the project is a commodity, the target behavior is purchasing, and the auxiliary behavior includes at least one of clicking, favoriting and commenting;
the interaction between the user and the project under the plurality of behaviors is used to characterize the situation that the user performs the target behavior and the auxiliary behavior on the commodity, and the attribute domain is used to characterize the attribute of the commodity.

The recommendation apparatus based on decoupling learning and target behavior guided learning 600 according to the embodiment of the present disclosure can implement the above method embodiment. Its implementation principle and technical effect are similar, so that this embodiment is not described in detail here.

It should be noted that the division of units in the embodiment of the present disclosure is schematic, which is only a logical function division. There may be another division method in actual implementation. In addition, each functional unit in each embodiment of the present disclosure can be integrated into one processing unit, or each unit can exist physically alone, or two or more units can be integrated into one unit. The above integrated unit can be implemented in the form of hardware or a software functional unit.

The integrated unit can be stored in a processor-readable storage medium if it is implemented in the form of a software functional unit and sold or used as an independent product. Based on this understanding, the technical solution of the present disclosure, in essence, or the part that contributes to the prior art, or all or part of this technical solution, can be embodied in the form of a software product. The software product is stored in a storage medium and includes several instructions to cause a computer device (which may be a personal computer, a server, a network device, etc.) or a processor to execute all or part of the steps of the method described in various embodiments of the present disclosure. The aforementioned storage medium includes: a USB flash disk, a mobile hard disk, a Read-Only Memory (ROM), a Random Access Memory (RAM), a magnetic disk or an optical disk and other media that can store a program code.

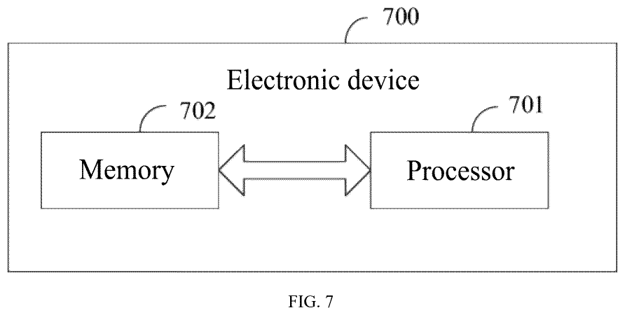

As shown in FIG. 7, the embodiment of the present disclosure provides an electronic device 700, which includes a memory 702, a processor 701 and a program stored in the memory 702 and executable on the processor 701. The processor 701 is configured to read the program in the memory 702 to implement the steps in the recommendation method based on decoupling learning and target behavior guided learning as described above.

The embodiment of the present disclosure further provides a readable storage medium in which a program is stored. The program, when executed by a processor, implements all the processes of the embodiment in the recommendation method based on decoupling learning and target behavior guided learning, and can achieve the same technical effect, so to avoid repetition, which is not described in detail here. The readable storage medium can be any available medium or data storage device that the processor can access, including but not limited to a magnetic memory (such as a floppy disk, a hard disk, a magnetic tape, a Magneto-Optical Disk ((MO), etc.), an optical memory (such as a Compact Disk (CD), a Digital Versatile Disc (DVD), a Blu-ray Disc (BD), a High-Definition Versatile Disc (HVD), etc.), and a semiconductor memory (such as a Read-Only Memory, ROM), an Erasable Programmable Read-Only Memory (EPROM), an Electrically Erasable Programmable Read-Only Memory (EEPROM), a non-volatile memory (NAND FLASH), a Solid State Disk or a Solid State Drive (SSD)), etc.

It should be noted that in the present disclosure, the terms “including”, “comprising” or any other variation thereof are intended to cover non-exclusive inclusion, so that a process, a method, an article or an apparatus including a series of elements includes not only those elements, but also other elements not explicitly listed, or elements inherent to such process, method, article or apparatus. Without more restrictions, an element defined by the phrase “including one” does not exclude the existence of other identical elements in the process, method, article or device including the element.

Through the description of the above embodiments, those skilled in the art can clearly understand that the method of the above embodiments can be implemented by means of software in combination with a necessary general hardware platform, and of course the method can also be implemented by hardware, but in many cases, the former is the better embodiment. According to this understanding, the technical solution of the present disclosure, in essence, or the part that contributes to the prior art, can be embodied in the form of a software product. The computer software product is stored in a storage medium (such as a ROM/RAM, a magnetic disk and an optical disk) and includes several instructions to cause a terminal (which may be a mobile phone, a computer, a server, an air conditioner or a network device, etc.) to execute the method described in various embodiments of the present disclosure.

The embodiments of the present disclosure have been described above with reference to the attached drawings, but the present disclosure is not limited to the above specific embodiments. The above specific embodiments are only schematic rather than limited. Under the inspiration of the present disclosure, those skilled in the art can make many forms without departing from the purpose of the present disclosure and the protection scope of the claims, which are all within the protection of the present disclosure.

1. A computer-implemented recommendation method for improving the accuracy of a computer-based recommendation system by overcoming the technical problem of recommendation inaccuracy caused by coarse-grained user preferences and noise from auxiliary user behaviors based on decoupling learning and target behavior guided learning, comprising:
constructing, by a processor, a user item graph under each of a plurality of behaviors based on an interaction between a user and an item under the plurality of behaviors, wherein the user item graph comprises a user node for characterizing the user and an item node for characterizing the item, and the plurality of behaviors comprise a target behavior and an auxiliary behavior;
performing, by a processor, decoupling attribute domain characterization processing on the user item graph to obtain fine-grained project decomposition embedding corresponding to the item node and fine-grained user decomposition embedding corresponding to the user node in a plurality of decoupled attribute domains, wherein the performing decoupling attribute domain characterization processing comprises: in each of the attribute domains, projecting an initial item embedding eᵢ into embedding of the attribute domain by using a pre-learned projection matrix W_{b}∈ [symbol] to obtain the project decomposition embedding e_{i,a} as follows:
$${e}_{i , a} = \frac{{W}_{b} {e}_{i}}{{‖ {W}_{b} {e}_{i} ‖}_{2}}$$
for the plurality of attribute domains corresponding to each of the user item graphs, calculating, by a processor, an attention score between the user node under each of the attribute domains and an item node adjacent to the user node based on the fine-grained item decomposition embedding and the user decomposition embedding, wherein the calculating an attention score comprises: (i) determining a mean value of the item decomposition embedding of all adjacent item nodes interacted with by the user node in the attribute domain as a query vector q_{u,a} corresponding to the user node; and (ii) calculating the attention score
$${α}_{u , i}^{a}$$
between the user node u and the item node i as follows:
$${α}_{u , i}^{a} = Softmax \{ {W}_{a} [ {q}_{u , a} ; {e}_{i , a}^{0} ] \}$$
wherein the target-behavior-guided attention score assigns a higher weight to project attributes relevant to the target behavior, thereby reducing the influence of noise data from the auxiliary behavior;
performing, by a processor, aggregating processing on the user node and the item node based on the attention score to obtain refined user target embedding and item target embedding under each of the behaviors; and
performing, by a processor, analysis processing in combination with the user target embedding and the item target embedding under the plurality of behaviors to generating, based on a combination of the refined user target embedding and item target embedding under the plurality of behaviors, a final set of computer data representing a recommended result for display to a user.

2. The method according to claim 1, wherein performing decoupling attribute domain characterization processing on the user item graph to obtain item decomposition embedding corresponding to the item node and user decomposition embedding corresponding to the user node in a plurality of decoupled attribute domains comprises:
constructing the plurality of decoupled attribute domains, and acquiring user initial embedding corresponding to the user node and initial item embedding corresponding to the item node; and
decomposing the initial project embedding in each of the attribute domains to obtain the item decomposition embedding in the attribute domain, and determining the user decomposition embedding in each of the attribute domains based on the user initial embedding.

3. (canceled)

4. (canceled)

5. (canceled)

6. The method according to claim 1, wherein performing aggregating processing on the user node and the item node based on the attention score to obtain user target embedding and item target embedding under each of the behaviors comprises:
aggregating the user node and the item node adjacent to the user node based on the attention score to obtain user aggregation embedding, and aggregating the item node and a user node adjacent to the item node to obtain item aggregation embedding; and
adding the user aggregation embedding in all of the attribute domains under the same user item graph to obtain user target embedding under the behavior, and adding the item aggregation embedding in all of the attribute domains under the same user item graph to obtain item target embedding under the behavior.

7. The method according to claim 1, wherein the project is a commodity, the target behavior is purchasing, and the auxiliary behavior comprises at least one of clicking, favoriting and commenting; and
the interaction between the user and the item under the plurality of behaviors is used to characterize the situation that the user performs the target behavior and the auxiliary behavior on the commodity, and the attribute domain is used to characterize the attribute of the commodity.

8. A recommendation apparatus based on decoupling learning and target behavior guided learning, comprising:
a construction module, which is configured to construct a user item graph under each of a plurality of behaviors based on an interaction between a user and an item under the plurality of behaviors, wherein the user item interaction graph comprises a user node for characterizing the user and an item node for characterizing the item, and the plurality of behaviors comprise a target behavior and an auxiliary behavior;
a decoupling characterization module, which is configured to perform decoupling attribute domain characterization processing on the user item graph to obtain item decomposition embedding corresponding to the item node and user decomposition embedding corresponding to the user node in a plurality of decoupled attribute domains, wherein the performing decoupling attribute domain characterization processing comprises: in each of the attribute domains, projecting an initial item embedding eᵢ into embedding of the attribute domain by using a pre-learned projection matrix W_{b}∈ [symbol] to obtain the project decomposition embedding e_{i,a} as follows:
$${e}_{i , a} = \frac{{W}_{b} {e}_{i}}{{‖ {W}_{b} {e}_{i} ‖}_{2}} ;$$
an attention calculation module, which is configured to, for the plurality of attribute domains corresponding to each of the user item graphs, calculate an attention score between the user node under each of the attribute domains and an item node adjacent to the user node based on the item decomposition embedding and the user decomposition embedding, wherein the calculating an attention score comprises: (i) determining a mean value of the item decomposition embedding of all adjacent item nodes interacted with by the user node in the attribute domain as a query vector q_{u,a} corresponding to the user node; and (ii) calculating the attention score
$${α}_{u , i}^{a}$$
between the user node u and the item node i as follows:
$${α}_{u , i}^{a} = Softmax \{ {W}_{a} [ {q}_{u , a} ; {e}_{i , a}^{0} ] \} ;$$
an aggregation processing module, which is configured to perform aggregating processing on the user node and the item node based on the attention score to obtain user target embedding and item target embedding under each of the behaviors; and
an analysis processing module, which is configured to perform analysis processing in combination with the user target embedding and the item target embedding under the plurality of behaviors to obtain a recommended result.

9. An electronic device, comprising: a memory, a processor, and a program stored in the memory and executable on the processor; wherein the processor is configured to read the program in the memory to implement the steps in the recommendation method based on decoupling learning and target behavior guided learning according to claim 1.

10. A non-transitory computer-readable storage medium in which a program is stored, wherein the program, when executed by a processor, implements the steps in the recommendation method based on decoupling learning and target behavior guided learning according to claim 1.
